(19) United States
(12) Patent Application Publication
(10) Pub. No.: US 2019/0039326 A1
(43) Pub. Date: Feb. 7, 2019

(54) UNIT FOR ASSEMBLING AND/OR TREATING COMPONENTS

(71) Applicant: INOVIA TECHNOLOGIES SA, Bex (CH)

(72) Inventors: Jean-Pierre Voigtmann, Muraz (CH); Daniel Kohlenbrenner, Miex (CH)

(73) Assignee: INOVIA TECHNOLOGIES SA, Bex (CH)

(21) Appl. No.: 16/074,625

(22) PCT Filed: Feb. 10, 2016
(86) PCT No.: PCT/EP2016/052861

§ 371 Date: Aug. 1, 2018

(51) Int. Cl. B29C 65/78; B29C 31/00; B29C 65/80; B29D 23/20; B29C 65/02

(52) U.S. Cl. CPC B29C 65/7885; B29C 31/002; B29C 65/7873; B29C 2793/009; B29D 23/20; B29C 65/02; B29C 65/80

(57) ABSTRACT

A device for manufacturing and/or treating components such as flexible tubes from prefabricated tubular bodies includes at least means for supporting the components and means for moving the components in line with a plurality of work stations. The device includes transport means along a main closed path for a plurality of satellite turrets rotatingly mounted on the transport means. The satellite turrets include means for holding a plurality of components, and each satellite turret is rotated by a predetermined angle around its rotation axis when the satellite turret reaches at least one predetermined point of the main path.

### TECHNICAL FIELD

The present invention relates to the field of devices for manufacturing and/or treating components. It more particularly relates to a device for manufacturing and/or treating flexible tubes comprising a skirt and a shoulder, obtained from prefabricated tubular bodies, and more specifically the assembly of tube components.

### BACKGROUND OF THE INVENTION

It is well known that in general, a flexible tube is made by assembling two parts manufactured separately, namely a cylindrical flexible skirt with a predetermined length and a head comprising a neck with a dispensing orifice and a shoulder connecting said neck to said cylindrical skirt.

Said head, which is generally made from plastic, can either be molded separately, then welded on one end of the cylindrical skirt, or molded and welded autogenously to the cylindrical skirt by any method known by those skilled in the art, for example an injection molding method or a compression molding method for an extruded blank, for example.

In order to carry out the assembly operations of the skirt, the shoulder of the seal and the stopper in particular, indexing rotary devices are well known.

These indexing rotary devices work through intermittent movements. The rotating part of the device is made up of a turret bearing mandrels that move successively from one work station to another, said mandrels transporting the tubes during manufacturing. The indexing device makes it possible to perform the assembly operations when the turret is stopped, the cycle of the turret being divided into a rotation time, also called indexing time, and a stop time. When the rotation of the turret is stopped, the assembly operations are performed, such as the loading of the tube shoulder on the mandrel, the loading of the tube skirt on said mandrel, the heating of the zone to be welded, the welding of the skirt on the shoulder, the sealing, the plugging, etc.

Thus, the reduction in the work time is limited by the duration of the operations, the work time being determined by the longest operation, usually the compression molding operation, which requires a cooling time before the performance of the following operation.

In order to optimize the work time, devices have already been conceived making it possible to reduce the indexing time. This is in particular the case for documents WO 2004/026567 and EP 2,364,247.

Document WO 2004/026567 describes an installation used to produce and package tubes made up of a tubular body formed in at least one plastic film and a shoulder part connected to one end and provided with a threaded neck and a placed closing stopper. The tubes are brought by a transport belt to a packaging station, where they are packaged in larger units. According to the invention, the strip of film is a double or multiple strip that is cut by one or several sectioning knives into individual strips that are respectively welded in parallel planes in endless pipes and are cut to the desired length by transverse cutting devices. Then, the sectioned tubular bodies produced in parallel are gathered into a larger transfer group and are transmitted together onto a rotating plate that has a corresponding number of mandrels and that brings them together and step by step to stations where the shoulder part provided with a threaded neck and the closing stopper are placed. Next, the completed tubes are deposited on an outlet belt made up of at least two adjacent parallel synchronous belts provided with transport prisms, the distribution of which corresponds to that of the pins on the rotating plate, and are brought to inspection zones, where they are checked.

The assembly device, shown in FIG. 1, is made up of a rotating plate 1 on which mandrels 2 are arranged placed in a polygon on the periphery of the plate, said mandrels 2 being intended to receive tubular bodies, not shown in the figure. Said plate 1 is rotated discontinuously and performs indexed movements. During its stop phase, station blocks 3, initially extending above the mandrels 2 of the rotating plate 1, descend until coming into contact with the tubular bodies to perform their work, i.e., the loading of the tube shoulder on the mandrel, the loading of the tube skirt on said mandrel, the heating of the zone to be welded, the welding of the skirt on the shoulder, the sealing, the plugging, etc., then the station blocks 3 rise again in order to release the rotating plate 1 so that it can perform a new indexing phase, the vertical movement of the station blocks being shown by the arrow a.

The optimization of the indexing time of this type of device is limited by the inertia of the turret, the diameter of which increases quickly with the number of mandrels in parallel. Thus, aside from the significant bulk of this type of device, it does not make it possible to treat a large number of tubes per unit of time. Indeed, the arrangement of the mandrels requires a movement of the work stations to free the mandrels before the rotation of the plate, the movement of these work stations causing large mass movements. Furthermore, practically each work station requires devices such as a linear guide and an actuator to perform its movement, which results in increasing the bulk of the entire device and decreasing the accessibility of the work stations. Lastly, the plate performing the indexing movements generates considerable vibrations and requires much energy, upon each indexing, to accelerate the total mass of the plate in motion.

Document EP 2,364,247 describes a device for manufacturing tubes, with several arrangements of mandrels each comprising several mandrels on which the tubes can be manufactured progressively on several work stations. The arrangements of mandrels can be transported using transport means, in the case at hand a rotary turret, from one work station to another. Said mandrels of at least one of the arrangements of mandrels are subdivided between a first and at least one second group of mandrels and the first group of mandrels, on at least one of the work stations, can be moved between a machining position associated with the work station, in which the work station can cooperate with the first group of mandrels, and a parking position associated with the work station, while the second group of mandrels is moved between a parking position associated with the work station and a machining position associated with the work station. Said movement from the parking position to the machining position is done by a radial translation.

This type of device, although making it possible to increase the number of tubes per unit of time, has the same drawbacks as those of the device described in document WO 2004/026567.

### BRIEF DESCRIPTION OF THE INVENTION

One aim of the invention is to resolve at least one of these drawbacks by proposing a device for manufacturing and/or treating components, such as flexible tubes, for example, with a simple and inexpensive design, having a reduced bulk, procuring a large number of treated tubes per unit of time and generating few vibrations.

To that end, and according to the invention, proposed is a device for manufacturing and/or treating components such as flexible tubes from prefabricated tubular bodies, for example, said device including at least means for supporting the components, means for moving said components in line with a plurality of work stations; said device is remarkable in that it includes transport means along a so-called main closed path for a plurality of so-called satellite turrets mounted rotating on said transport means, said satellite turrets including means for holding a plurality of components and each satellite turret being rotated by a predetermined angle around its rotation axis when said satellite turret reaches at least one predetermined point of the main path.

Unlike the devices of the prior art where the work stations must necessarily clear the mandrels before the rotation of the plate, several times for a complete revolution of the plate, according to the invention, the work stations only clear the mandrels once, during the rotation of the satellite turret, for a complete revolution of the transport means. Thus, the time available for the work stations is ultimately much greater and makes it possible to treat a larger number of tubes per unit of time.

Furthermore, another advantage of the present invention lies in the fact that it is possible to obtain a precise stopping point on the satellite turrets with a long enough stop time, making it possible for example to deposit a tube component or a dose of plastic material for example intended to form the shoulder, without interrupting the rotation of the transport means.

Lastly, the device according to the invention allows a skirt, for example, that has been transferred at a given moment continuously on a satellite turret, to perform several revolutions on the transport means while changing position on said transport means upon each performed revolution. This movement of the skirt on the transport means allows the skirt to pass below different work stations placed on board and fastened on the transport means, or in line with said transport means and, at a given moment, to leave said transport means according to the same principle as upon assembly and still continuously.

Preferably, the transport means consist of a so-called main turret mounted rotating around an axis.

Furthermore, the rotation axes of the satellite turrets preferably extend parallel to the rotation axis of the main turret.

Furthermore, said satellite turrets are rotated in a direction opposite that of the main turret.

Said satellite turrets are rotated by an angle corresponding to a value of 360° divided by the number of means for holding said satellite turret or a multiple of this value.

Advantageously, the rotation axis of the satellite turret is moved radially during all or part of its angular rotation.

Preferably, the rotation axis of the satellite turret is moved radially toward the rotation axis of the main turret during the first half of its angular rotation, then radially toward its initial position during the second half of its angular rotation.

The synchronization of the two movements between, on the one hand, the rotation of the satellite turrets, and on the other hand, the radial movement of the satellite turrets, makes it possible to obtain, at a given moment, a precise stopping point on the satellite turrets with a defined stopping time.

Furthermore, the device according to the invention includes means for rotating each satellite turret.

Preferably, the components consist of prefabricated tubular bodies and in that the holding means consist of semi-cylindrical cavities, the axes of which extend parallel to the rotation axis of each satellite turret, over a circle coaxial to the rotation axis of each satellite turret, each cavity including suction means for keeping the prefabricated tubular bodies in place in said cavities.

Furthermore, the device according to the invention includes a plurality of mandrels extending in line with said holding means and able to move from a retracted position toward a so-called treatment position in which said mandrels extend inside the prefabricated tubular bodies.

In order to procure the movement of said mandrels, the device according to the invention includes means for actuating the mandrels from their retracted position toward their treatment position.

Said actuating means of the mandrels consist of mechanical actuating means made up of stationary mechanical cams extending around the main turret.

Preferably, said satellite turrets are uniformly distributed around the rotation axis of the main turret.

According to one preferred embodiment, the main turret is rotated continuously, preferably at a constant speed.

Because the main turret rotates continuously, this results in the possibility of using any appropriate means, such as a vacuum wheel, for example, to help transfer the skirts continuously into the cavities of the satellite turrets, resulting in creating a fluid movement of the skirts, particularly given that the latter most often come from a first continuous production step.

It will be noted that the transfer systems of the prior art by indexed movement require several operations before being able to transfer the skirts, such as collecting skirts arriving continuously. Furthermore, the indexed transfer movements of the devices of the prior art generate significant vibrations due to the moving masses and are limited in terms of rhythm due to the to-and-fro movements. Thus, the continuous transfer according to the invention makes it possible to work at much faster rhythms than indexed transfer systems.

Another important point lies in the fact that when the compression molding method is used to produce the shoulder of a tube, the closing time of the mold, phase where the dose of plastic material is shaped and cooled at the same time, is an important factor in the dimensioning of the machine. As previously explained, the time available for a work station is much longer in an assembly device according to the invention than on a device of the prior art, this time being able to be 8 times greater than for a device of the prior art.

Thus, in the devices of the prior art, it is necessary to multiply the mandrels on the plate as well as the corresponding work stations by 8 to perform the same work in the same amount of time, which would lead to an even greater bulk of these devices of the prior art.

Advantageously, said means for driving the rotation of each satellite turret are synchronized with the radial movement means of the rotation axes of each satellite turret so as to create a decrease in the speed of a point of each satellite turret relative to the main turret and/or a stopping point of a point of each satellite turret relative to the main turret.

### BRIEF DESCRIPTION OF THE DRAWINGS

Other details of the invention will appear more clearly upon reading the following description, done in reference to the appended drawing, in which:

FIG. 1 is a schematic perspective view of the turret of the assembly device of the prior art described in document WO 2004/026567,

FIG. 2 is a perspective view of the manufacturing device, the assembly device and the filling device for flexible tubes according to the invention,

FIG. 3 is a perspective view of the turret of the assembly device according to the invention,

FIG. 4 is a partial perspective view of the turret and the tool station of the assembly device according to the invention,

FIG. 5 is a perspective view of the turret, the tool station and transfer means of the assembly device according to the invention,

FIGS. 6a to 6e are schematic top views of the kinematics of a satellite turret during the rotation of the main turret of the assembly device according to the invention,

FIG. 7 is a top view of an alternative embodiment of the assembly device according to the invention in which the main turret is substituted by a chain conveyor,

FIG. 8 is a schematic perspective view of the reel and the printing station of the flexible tube manufacturing device according to the invention,

FIG. 9 is a partial perspective view of the reel of the tube manufacturing device according to the invention,

FIG. 10 is a perspective view of the means for turning over the strip of the manufacturing device according to the invention,

FIG. 11 is a perspective view of the unit for forming the skirts of the manufacturing device according to the invention,

FIG. 12 is a sectional and perspective view of the lateral driving unit of the unit for forming the skirts of the manufacturing device according to the invention,

FIG. 13 is a perspective view of the device for filling flexible tubes according to the invention,

FIG. 14 is a perspective view of the device for transferring flexible tubes between the assembly device and the device for filling flexible tubes according to the invention,

FIG. 15 is a perspective view of a unit for dosing “rollings” of a tool station of the assembly device according to the invention.

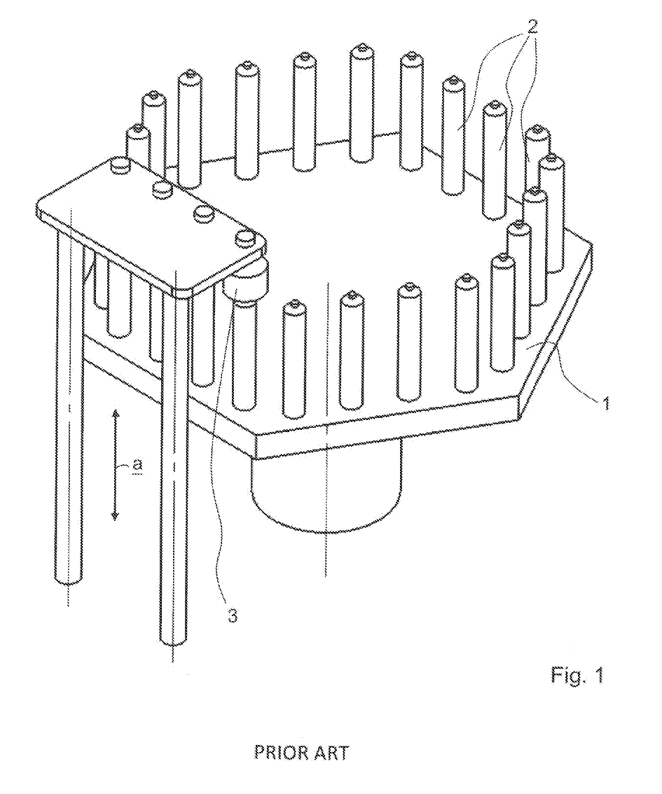

### DETAILED DESCRIPTION OF THE INVENTION

Below, we describe an installation for manufacturing and filling flexible tubes, and more particularly a device for assembling flexible tubes; however, it is clear that the assembly device according to the invention may be suitable for assembling any type of components without going beyond the scope of the invention.

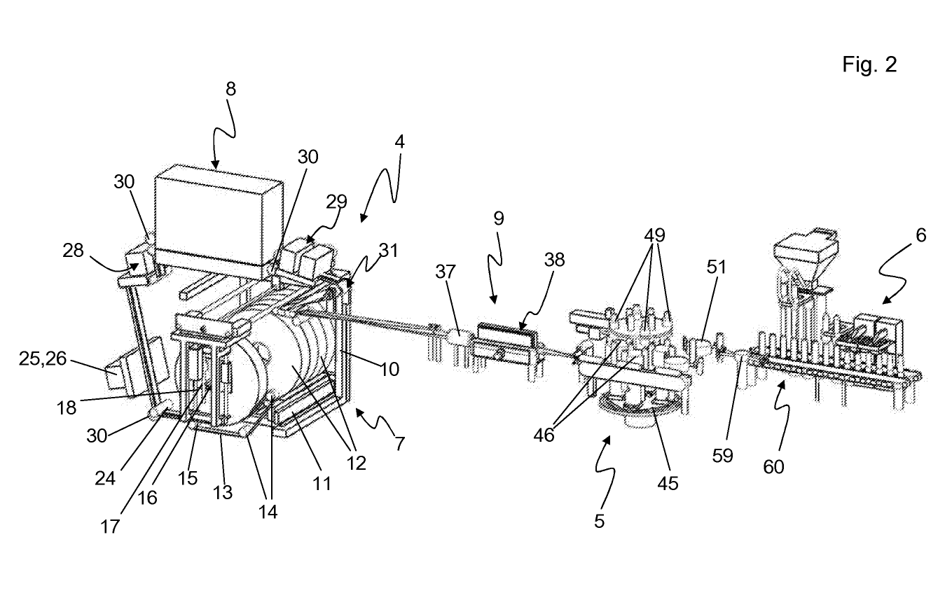

In reference to FIG. 2, the installation for manufacturing and filling flexible tubes according to the invention is made up of a manufacturing device 4, an assembly device 5 and a filling device 6.

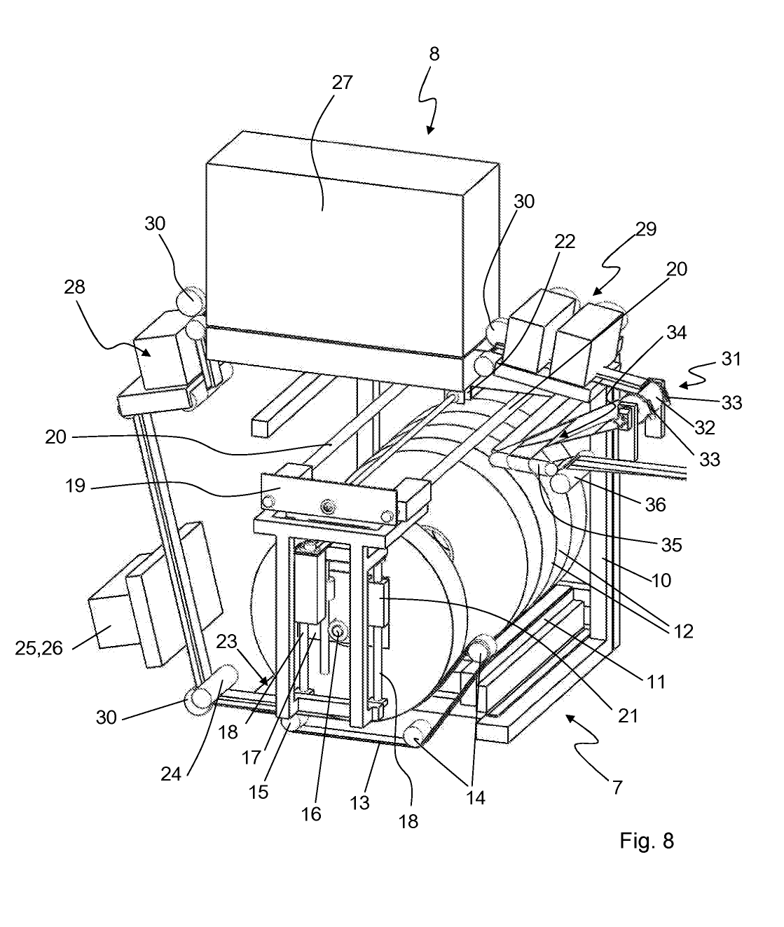

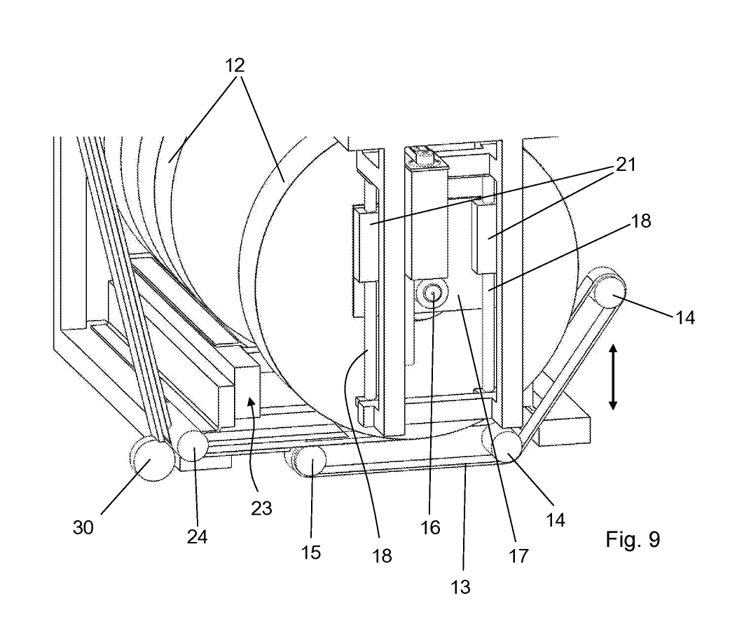

Said manufacturing device 4, in reference to FIGS. 2 and 8, includes a reel 7, a printing unit 8 and a tubular body manufacturing unit 9. Said reel 7 is made up of a frame 10 including, at its base, on the one hand a lateral slide 11 on which are positioned rolls of laminate 12 used in the manufacture of flexible tubes, and on the other hand, a drive belt 13 on which a roll of laminate bears to be unwound, said drive belt 13 extending between tension rollers 14 and a drive roller 15. Said drive roller 15 is rotated by an electric motor, not shown in the figures.

Said reel 7 further includes an expandable mandrel 16 for holding the unwound roll 12, said expandable mandrel 16 being mounted on a rotating bearing and engaged with the inner washer extending in the central part of the roll of laminate 12, secured to a carriage 17 able to be moved vertically, i.e., perpendicular to the rotation axis of the roll of laminate 12, along vertical rails 18. Said vertical rails 18 are secured to the lower end of a second carriage 19 able to be moved horizontally, parallel to the rotation axis of the roll of laminate 12, along horizontal rails 20 secured to the frame 10. In order to allow the carriages 17 and 20 to move, the reel 7 includes motors 21 and 22, respectively, said motors 21 and 22 being able to be electric motors.

Of course, the electric motors 21, 22 could be replaced by pneumatic or hydraulic actuators, for example, without going beyond the scope of the invention.

Thus, the expandable mandrel 16 seeks out, one by one, the roll of laminate 12 stored on the lateral slide 11, the rolls of laminate 12 having been deposited beforehand on the slide by an operator, to deposit them on the drive belt 13 of the reel 7 where the roll is progressively completely unwound. The roll of laminate 12, during its unwinding, is gradually lowered based on the decrease in its outer diameter, via the gradual descent of the carriage 17, so as always to keep good contact between the outer face of the roll of laminate 12 and the drive belt 13, thus provided a rotation of the roll and a constant unwinding of the laminate independently of the diameter of the roll 12. During the gradual descent of the carriage 17, the tension roller 14 is advantageously also progressively lowered so that the contact of the drive belt 13 with the roll of laminate remains optimal. The drive means in the vertical plane of the tension roller 14 are not shown in the figures and may consist of any appropriate means that are well known by those skilled in the art.

When the roll of laminate 12 is completely unwound, an ejector, not shown in the figures, positioned near the expandable mandrel 16, ejects the inner washer of the roll of laminate 12 before seeking out the next roll of laminate 12.

It will be understood that, unlike the reels of the prior art that are made up of two reels that work by alternating and that require the operator to change the rolls once both the rolls on the reels are empty, the reel according to the invention allows the operator to fill the loading slide with several rolls 12 at intervals that suit him, which makes it possible to considerably increase the time between two operator interventions, leaving him free for other activities around the installation.

Furthermore, another advantage of the reel 7 according to the invention lies in the fact that the operator does not need to prepare the beginning of the roll to allow the junction with the end of the previous roll of laminate, the junction most often being done with tape in the reels of the prior art, which is likely to give if the tape has not been applied properly by the operator, thus causing the machine to stop. Indeed, in the reel 7 according to the invention, the beginning of the laminate of a roll is brought through the machine automatically. Thus, the operator does not need to prepare and pull the beginning of the laminate of each roll through the return rolls to the connecting station of the two laminates.

According to one alternative embodiment of the device according to the invention, not shown in the figures, the latter can advantageously comprise two combined reels that work by alternating to procure continuity of the laminate in the machine. In this way, when a roll of laminate of a first reel is nearly empty, the second reel begins to rotate so that the beginning of the roll of the second reel can follow the end of the roll of the first reel. The first reel can then prepare a new roll of laminate while the roll of the second reel is gradually emptied and be ready to take over once the roll of laminate of the second reel is completely empty.

Furthermore, in reference to FIGS. 2, 8 and 9, the reel 7 includes a suction unit 23 positioned in line with the drive belt 13 and making it possible to collect the beginning of the laminate of the roll 12 to cause it to pass between two guides 24 that make it possible to bring the laminate to a lateral drive unit that will be outlined later. The laminate then advantageously passes in line with a strip cleaner 25 to remove the impurities deposited on the inner and outer layer of the laminate and in line with a surface treatment device 26 to improve the adhesion of the ink on said laminate during printing, as will be outlined later.

At the upper end of the frame 10, the reel 7 includes a printing unit 27 through the inlet of which a strip guide 28 is positioned making it possible to stabilize and position the laminate laterally. This printing unit 27 makes it possible, if necessary, to print the laminate before transforming the laminate in the form of tubular bodies. At the outlet of the printing unit 27, the reel 7 includes a drying unit 29 below which the printed laminate passes in order to dry the ink.

It will be noted that the device according to the invention also includes a plurality of relay drive units 30 placed appropriately on the outline of the laminate in order to guarantee the advance of the laminate by friction, each relay drive unit 30 traditionally being made up of a return roll and a rotated roll, the laminate being pushed through the guides from one relay drive unit 30 toward the next. In the case at hand, the device includes three relay drive units 30, a first relay drive unit 30 positioned at the outlet of the drive belt 13, a second relay drive unit 30 positioned at the inlet of the printing unit 27 and a third drive unit 30 positioned at the outlet of the printing unit 27 and the drying unit 29.

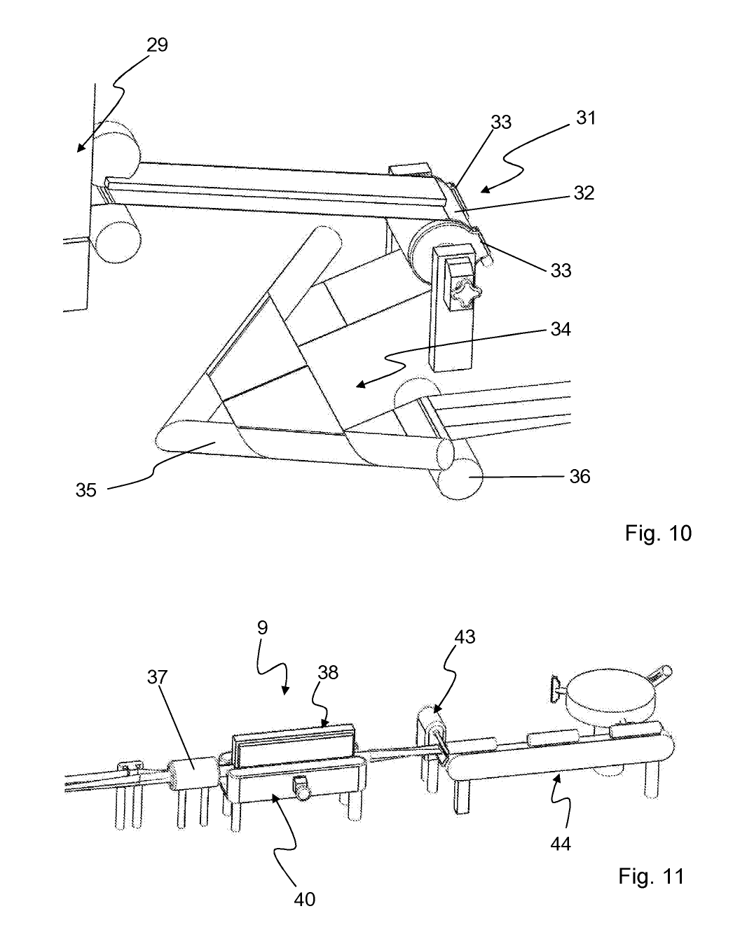

In reference to FIGS. 2, 8 and 10, the reel 7 further includes, at the outlet of the drying unit 29, a lateral cutting station 31 made up of a tension roll 32 with two lateral knives 33 that cut the edges of the laminate cleanly and define the width of the laminate needed based on the desired diameter of the skirt and a reversal device 34 of the laminate for inverting the upper surface of the laminate that has just been printed with respect to the lower surface of the laminate. Said reversal device 34 is made up of a generally V-shaped guide 35 positioned between the tension roll 32 of the lateral cutting station 31 and a second tension roll 36. This reversal operation is necessary in order to be able to wind the laminate around the welding rod of the welding station, as will be outlined later, and to keep the junction between the two edges of the laminate on top of said welding rod for the welding.

At the outlet of the reversal device 34, in reference to FIGS. 2 and 11, the laminate passes through a calibrating sleeve 37 that folds the laminate along its longitudinal axis so as to give it a tubular shape before passing through a welding station 38 that comprises a welding rod 39 extending between two belts of a lateral drive unit 40.

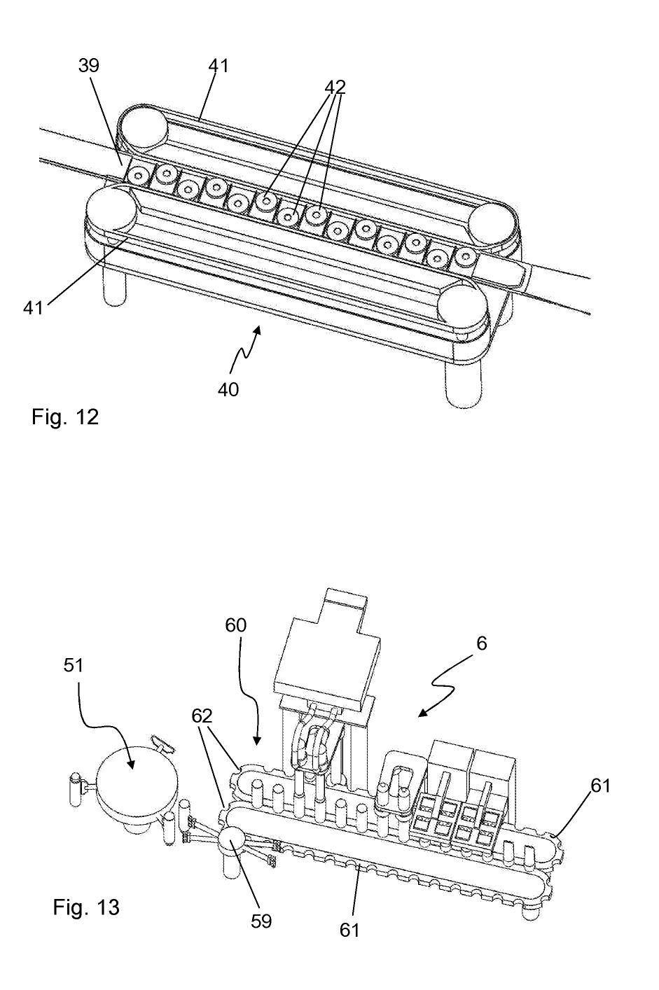

In reference to FIGS. 2, 11 and 12, said lateral drive unit 40 is made up of two parallel belts 41 rotated in opposite directions, the welding rod 39 extending parallel to the belts 41 between the latter. Advantageously, the lateral drive unit 40 includes, between the inlet and the outlet of the relay drive unit, a plurality of rolls 42 mounted loose and movable perpendicular to the travel direction of the laminate, i.e., perpendicular to the belts 41, said rolls 42 extending successively on either side of the longitudinal axis of the lateral drive unit 40 between its inlet and its outlet in the welding rod 39. Thus, these rolls 42 alternately come into contact with the laminate on one side or the other of the welding rod 39. This train of rolls 42 makes it possible to greatly decrease, or even eliminate, the friction forces created by the pressure of the laminate against the welding rod 39, said pressure being induced by the belts 41. Thus, by placing said rolls 42 in the welding rod 39, the necessary pressure between the belts 41 and the outer surface of the tube is preserved while eliminating the pressure of the laminate against the welding rod 39, since the laminate is pinched between the belts 41 and the rolls 42.

It will be noted that another advantage of said lateral drive unit 40 lies in the fact that the elimination of the friction around the welding rod 39 allows the laminate to remain stable during its advance without twisting around said welding rod 39, which improves the quality of the welding.

Furthermore, it will be noted that, when the laminate reaches the lateral drive unit 40, the drive belt 13 of the reel 7 as well as the relay drive units 30 are unkempt, only the lateral drive unit 40 seeing to the advance of the laminate. At the same time, a braking device, not shown in the figures, positioned on the drive of the drive belt 13 of the reel 7, creates tension in said laminate to provide an ideal holding of the laminate without vibration of the latter when it passes below the printing unit 27, the absence of vibration of the laminate being mandatory to obtain a good printing quality.

Furthermore, in reference to FIGS. 2 and 11, the manufacturing device 4 includes, at the outlet of the lateral drive unit 40, a transverse cutting station 43, which sections the tubular body obtained after the welding operation into tubular bodies with equal lengths, said tubular bodies commonly being called skirts, and a transfer conveyor 44 that brings the skirts tangentially toward the assembly device 5.

It will be noted that the transfer conveyor 44 brings the skirts tangentially toward the loading turret of the assembly device 5 where the skirts are grasped by the grasping members of said loading turret 17 in the horizontal position. After the grasping of the skirts, the grasping members perform, during the amount of time between the acquisition of the skirt on the transfer conveyor 44 and the transfer point into the cavity of a satellite target, as outlined later, a 90° rotation around their axis of symmetry.

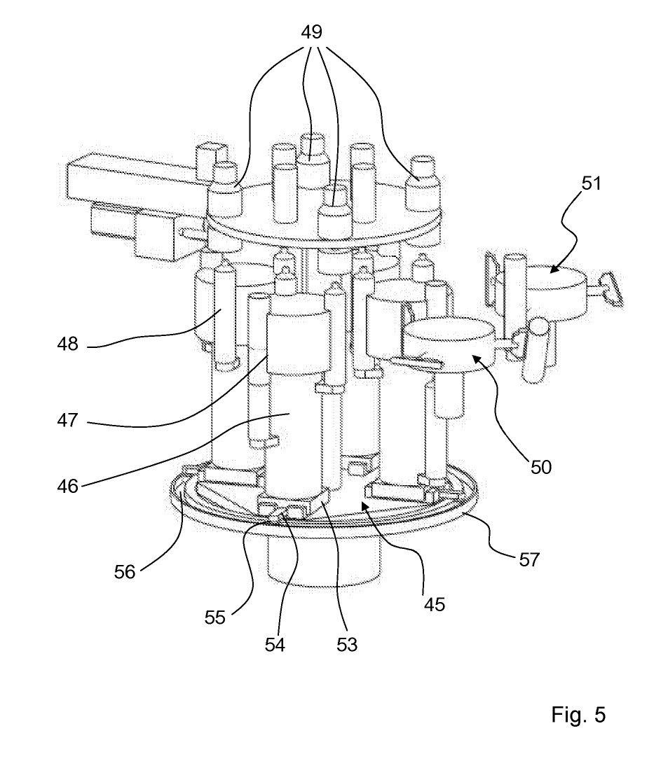

In reference to FIGS. 2 to 5, said assembly device 5 is made up of transport means 45 along a so-called main closed trajectory and a plurality of so-called satellite turrets 46 mounted rotating on said transport means 45, said satellite turrets 46 including means for holding a plurality of skirts and each satellite turret 46 being rotated by a predetermined angle around its rotation axis when said satellite turret 46 reaches at least one predetermined point of the main trajectory. In this example embodiment, the transport means 45 consist of a so-called main turret rotated around its vertical axis of symmetry and the holding means of the satellite turrets 46 consist of semi-cylindrical cavities 47, the axes of which extend parallel to the rotation axis of each satellite turret 46, each cavity 47 including suction means for keeping the prefabricated tubular bodies, i.e., the skirts, in place in said cavities 47.

Furthermore, the device includes a plurality of mandrels 48 extending in line with said holding means 47 and able to move from a retracted position toward a so-called treatment position in which said mandrels 48 extend inside the prefabricated tubular bodies, i.e., the skirts. Said device also includes means for actuating the mandrels 48 from their retracted position toward their treatment position, said actuating means not being shown in the figures. These actuating means of the mandrels 48 preferably consist of mechanical actuating means made up of stationary mechanical cams extending around the main turret 45. However, said actuating means of the mandrels 48 may consist of electric and/or pneumatic and/or hydraulic actuating means without going beyond the scope of the invention.

Said assembly device 5 comprises work stations 49 extending above the main turret 45 and satellite turrets 46, as well as a loading turret 50 and an unloading turret 51 positioned at the periphery of the main turret 45. Said main 45, loading 50 and unloading 51 turrets all rotate continuously. Preferably, the tangential speed of the skirts in the cavities of the loading 50 and unloading 51 turrets is substantially identical to the tangential speed of the skirts in the outer cavities of the satellite turrets 46, which allows an easy transfer of the skirts. Indeed, at the time of the transfer, the relative speed between the cavities of the loading 50 or unloading 51 turrets and the cavities of the satellite turrets 46 is then nil.

It will be noted that the cavities of the loading 50 and unloading 51 turrets are provided with gripping members including a slit, not shown in the figures, through which a vacuum is exerted making it possible to produce suction and optionally blowing, in order to provide effective fixing (suction) or removal (blowing) of the skirts.

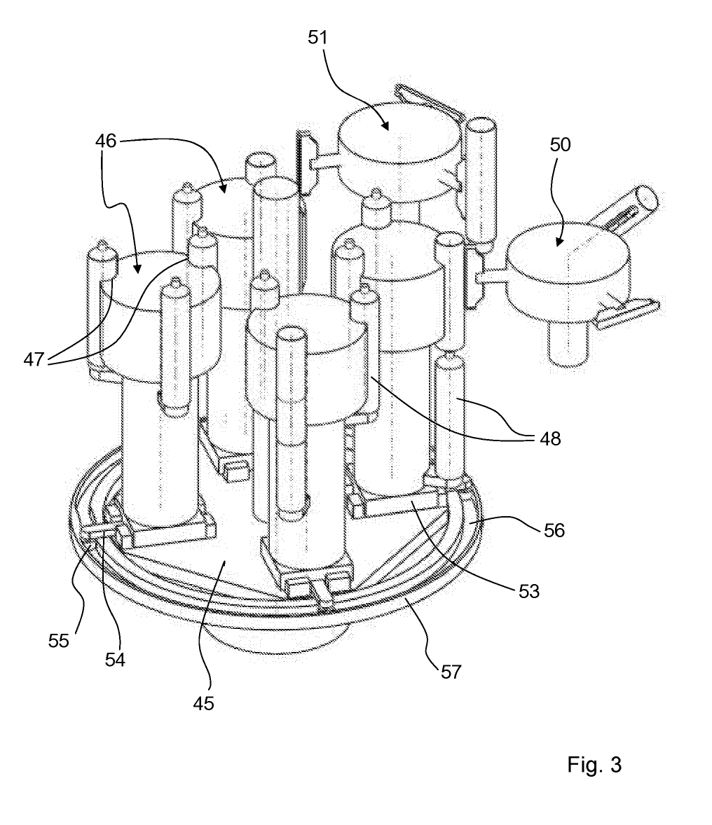

FIG. 3 shows the continuous transfer of a skirt between the loading turret 49 and the satellite turret 46. At that moment, the vacuum in the grasping member of the loading turret 49 is triggered and optionally the blowing is activated, while the vacuum of the grasping member of the cavity of the satellite turret 46 is actuated. In this FIG. 3, all of the satellite turrets 46 are in an angular position of the device where they are not rotating around their axis of symmetry. In this position, all of the work stations, not shown in this FIG. 3, are active. FIG. 3 also shows the continuous loading of the skirts on the moving mandrels 48, still without stopping the rotation of the main turret 45. In particular, on the satellite turret 46, the moving mandrel 48 is in the low position so as to allow the transfer of the skirt into the cavity of the satellite turret 46. Conversely, on another satellite turret 46, one can see the skirt partially loaded on the moving mandrel 48 that has already performed part of its travel following the vertical movement. On another satellite turret 46, one sees the moving mandrel 48 in the high position and the skirt completely loaded.

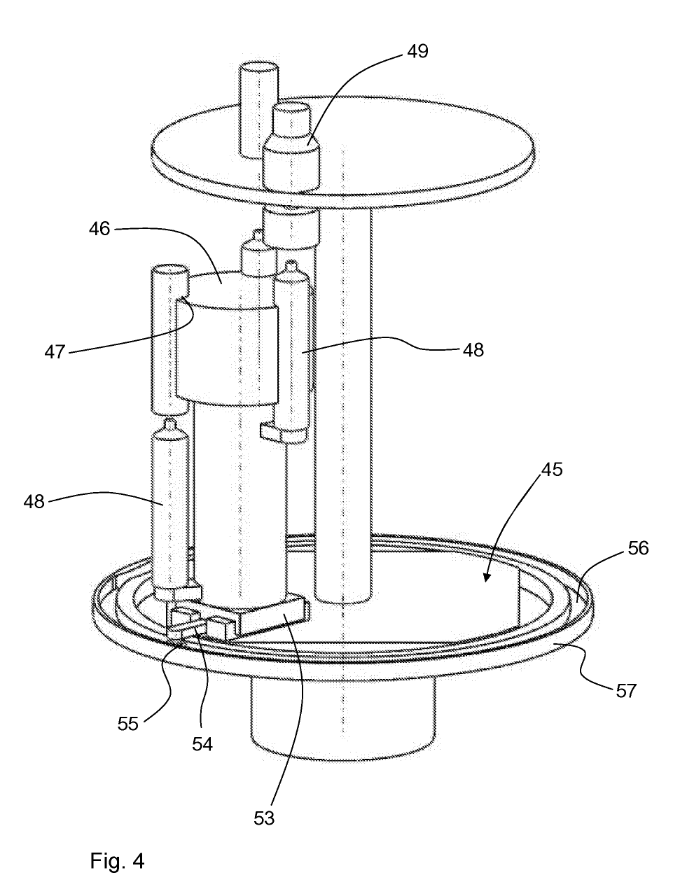

FIG. 4 illustrates the main turret 45 with a single satellite turret 46 and a single lot of work stations 46 (for better understanding of the operation of the unit). Each satellite turret 46 has a same lot of work stations 49. Each lot of work stations 49 comprises one or several work stations 49 that will successively carry out the various steps to assemble the tube components. The work stations 46 are mounted movable along a vertical movement axis so as to be able to come into contact with the two components once the satellite turret 46 is no longer rotating or moving radially, and to release the satellite turret 46 just before the latter begins to rotate.

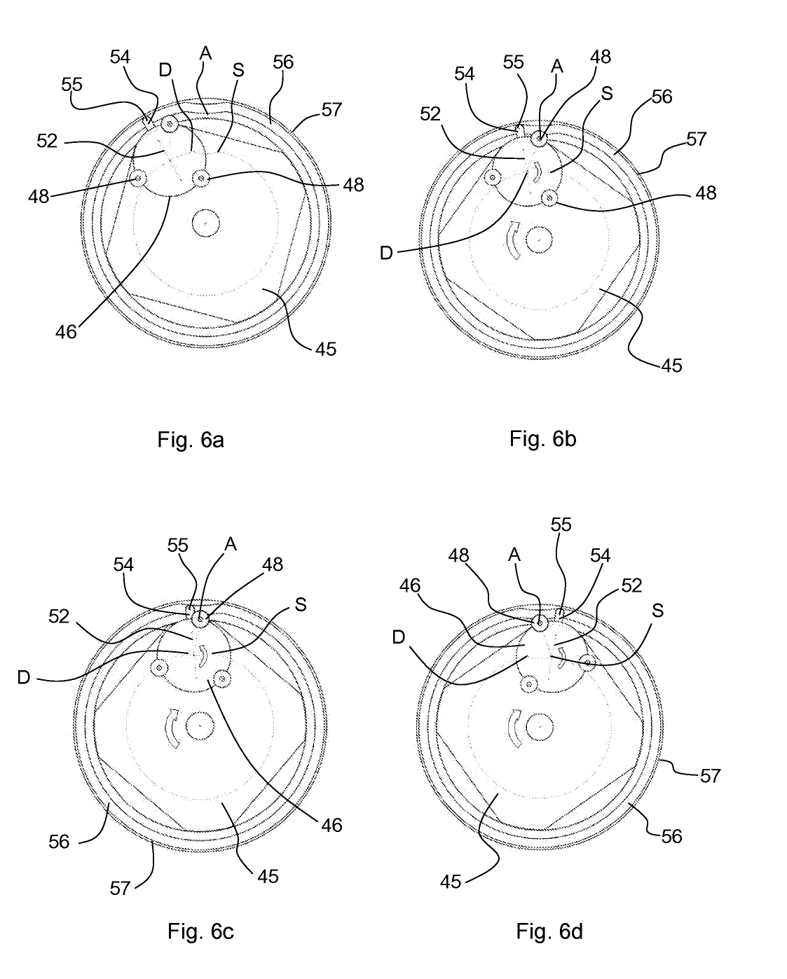

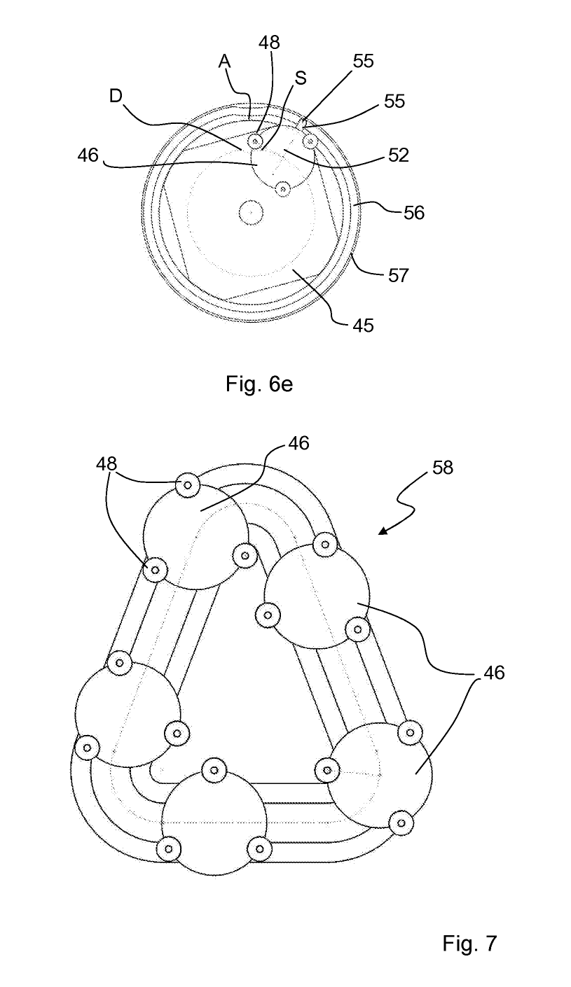

FIGS. 6a to 6e show a series of positions of a same satellite turret 46 in order to both create a stopping point A on the satellite turret 46 and at the same time have the satellite turret 46 rotate by an angular pitch corresponding to 360° divided by the number of cavities 47 of a satellite turret 46 in order to move the skirts toward the next work station 49, a single satellite turret 46 and none of the work stations being shown in order to simple five the understanding.

FIG. 6a shows the position of the satellite turret 46 before arriving at a predetermined point D. At this moment, the satellite turret 46 is not rotating along its axis of symmetry and the work stations are in contact with the tube components to perform their work.

FIG. 6b shows the position of the satellite turret 46 on point D. At this moment, the axis of symmetry of the cavity 47 of the satellite turret 46 and the mandrel 48, located on the point A, no longer move. Conversely, the satellite turret 46 begins to rotate on its axis of symmetry, and this axis of symmetry begins its radial movement along the axis 52. The work stations are no longer in contact with the tube components so as to allow the rotation and movement of the satellite turret 46.

FIG. 6c shows the position of the satellite turret 46 between the point D and the outlet point S. At this moment, the axis of symmetry of the cavity of the satellite turret 46 and the mandrel 48 is still located on the point A. The satellite turret 46 continues to rotate on its axis of symmetry and its axis of symmetry continues to move along the axis 52.

FIG. 6d shows the position of the satellite turret 46 on the outlet point S. At this moment, the axis of symmetry of the cavity of the satellite turret 46 and the mandrel 48, located on the point S, no longer moves. The satellite turret 46 continues its rotation phase around its axis of symmetry until the next work station, but no longer moves along the axis 52.

FIG. 6e shows the position of the satellite turret 46 at the outlet point S. At this moment, the satellite turret 46 has finished its rotation around its axis of symmetry and travel of its axis of symmetry along the axis 52. The work stations can again come into contact with the tube components in order to perform a new work cycle during the length of time where the satellite turret 46 performs the travel from the point S to the point D. However, it will be noted that the work stations must no longer be in contact with the tube components when the satellite turret 46 arrives at the point D.

It will be noted that the rotation of the satellite turret 46 around its axis of symmetry and the travel of its axis of symmetry along the axis 52 can be done in different ways, e.g., with mechanical, pneumatic or electric means. Advantageously, these operations can be done with two mechanical cams. Superimposing the laws of movement of the two cams makes it possible to obtain movements of the satellite turret 46 without jolts and an optimal and precise stopping point on the satellite turret 46.

In this particular example embodiment, in reference to FIGS. 3, 4, 5 and 6a to 6e, each satellite turret 46 is mounted rotating around its axis of symmetry on a carriage 53 able to move radially on the main turret 45. Each carriage 53 bears, at the end of an arm 54 secured to said carriage 53, a roller 55 forming a cam and extending in a slot 56 forming a cam path and formed in a stationary element 57 extending at the periphery of the main turret 45. Said slot 56 has a circular shape and includes, in at least one point, a convex side oriented toward the rotation axis of the main turret 45. Furthermore, the rotation of the satellite turrets 46 around the axis of symmetry is done using servomotors, not shown in the figures, actuating each axis of the satellite turrets 46 independently of one another.

Furthermore, the satellite turrets 46 can perform other rotation cycles around themselves at other points D during a complete revolution performed by the main turret 45, and there may be several stopping points A during a complete revolution performed by the main turret 45 without going beyond the scope of the invention.

According to one alternative embodiment of the invention, in reference to FIG. 7, the main turret 45 may be replaced by a chain conveyor 58 on which the satellite turrets 46 are mounted to move them along a closed trajectory. In this alternative embodiment, the conveyor 58 describes a substantially triangular path; however, said path may have any closed shape without going beyond the scope of the invention. In this embodiment, the radius of the satellite turrets 46 will advantageously be chosen such that it is identical to the radius of the primitive travel axis of the chains in at least one of the curves of the conveyor 58. Thus, if the axis of symmetry of the satellite turrets 46 coincides with the primitive travel axis of the chains of the conveyor 56, the stopping point above a cavity of a satellite turret 46 can be created at the curve of the conveyor 58, without stopping said conveyor 58 and without performing a rotational or translational movement of the satellite turret 46.

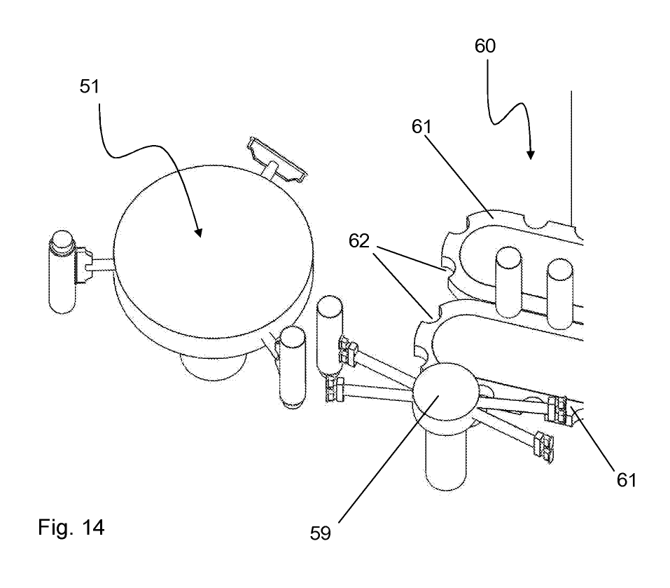

In reference to FIGS. 2, 13 and 14, the filling device 6 is positioned at the outlet of the assembly device 5 near the unloading turret 51. The grasping members on the unloading turret 51 perform, during the length of time between the acquisition of the tube in the cavity of a satellite turret 46 and the transfer point in the grasping members of a transfer turret 59, a 180° rotation along their axis of symmetry, in order to rotate the tube and position the rear part of the tube, still open, facing upward to perform the filling.

The grasping members of the transfer turret 59 collect the tubes coming from the unloading turret 51 and transfer them into a double conveyor 60 of the filling device 6, the transfer turret 59 performing rotating movements in the clockwise and counterclockwise directions so as to be able to collect several tubes before transferring them in turn into said double conveyor 60. It will be noted that in this way, it is possible to increase the stopping time of the double conveyor 60 necessary for the various work stations placed along the latter.

Said double conveyor 60 is made up of two belts 61 respectively including circular half-indentations 62, the circular half-indentations 62 of a first belt 61 extending in line with the circular half-indentations 62 of the second belt 61 to form, on the linear part of the conveyors, circular cavities able to receive the skirts, i.e., cavities with the same shapes and same dimensions as those of the tubes.

Thus, during the transfer phase, the tubes positioned vertically with the opening upward arrive continuously frontally in the interstitial space created by the two return wheels of the two belts 61 placed in parallel and rotating in opposite directions relative to one another, but at the same speed as the tangential speed of the transfer turret 59 during the transfer. Said tubes are received and kept between the two belts 61 once they arrive in the interstitial space.

It will be noted that the double conveyor 60 of the filling device 6 performs an indexed movement. During the advance phase, it receives several tubes and moves the tubes already in the double conveyor 60 toward the following work station, thus allowing the tubes to move successively toward the various work stations. Said work stations for example consist of:
a station for rotating the tubes that orients the position of the tubes in the double conveyor so that during the closing of the tube, the printing coincides perfectly with the back of the tube,
a filling station: filling operation of the tube,
a preheating station: which melts the inner layer of the tube over a distance of about 2-3 mm from the back of the tube,
a compression station: bending and compression operation of the melted zone on the back of the tube in order to hermetically seal the tube,
a cutting station: step for forming the length of the tube by making a cut in the weld so as to end the tube cleanly.

The tube is next freed from the double conveyor 60 when the two belts 61 bypass the return pulleys. The tube can next for example be conveyed onto a conveyor of a boxing machine or the like, not shown in the figures.

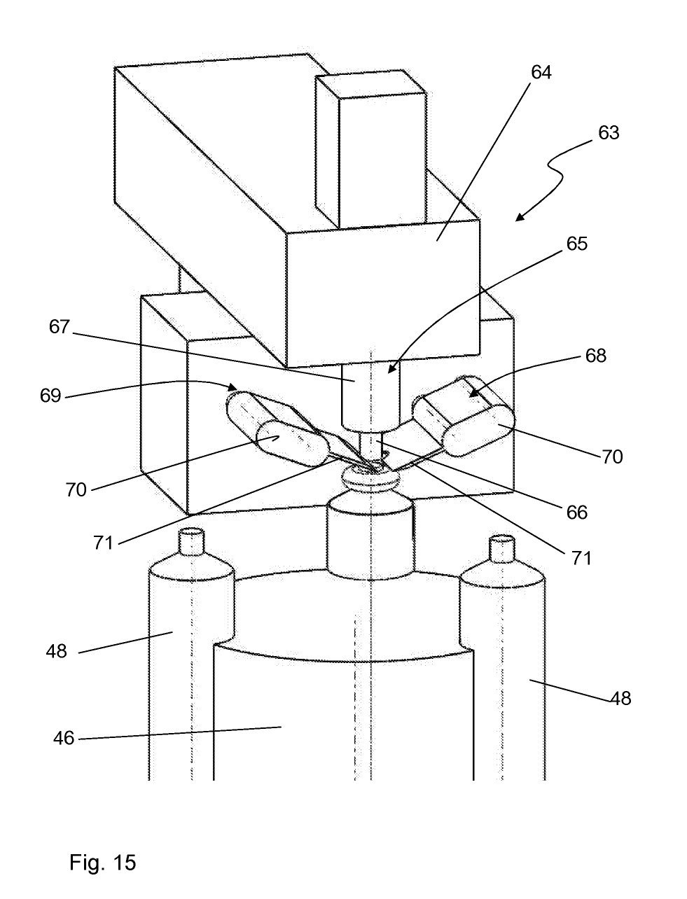

Secondarily, in reference to FIG. 15, one of the tools of the work stations of the assembly device consists of a so-called dosing unit 63 that is positioned above the stopping point of the satellite turrets 46. This dosing unit 63 makes toroidal doses of plastic with a central hole, more commonly called “donut” or “rolling”. The dosing unit 63 is made up of an extruder 64 making it possible to melt the plastic particles and to transfer this viscous material under high pressure into a dosing head 65. Said dosing head 65 will extrude a tubular plastic body vertically against the bottom around a valve rod 66 fastened to the end of a dosing valve 67, which makes it possible to cause the material to leave or not leave the dosing head 65.

The dosing unit 63 also includes a cutting device 68 that sections the tubular body into equal lengths so as to create “rollings”, which are next directly deposited successively on the mandrel heads. Said cutting device 68 placed below the dosing head 65 comprises a transmission box 69 for example actuated with a servomotor that drives two axes emerging from the gearbox. On each axis is a blade holder 70, such that the blades 71 are located on either side of the valve rod 66. These blades 71 perform an oscillating and symmetrical movement relative to the extruded tubular body, coming closer to one another until touching, thus sectioning the tubular body.

Thus, first, when the blades 71 come closer to the valve rod 66, the path followed by the sharp edge of each blade 71 is done substantially horizontally with a movement speed component against the bottom substantially identical to the movement speed of the tubular body until the tubular body is sectioned. The cutting thus obtained is clean without stretching of the tubular body. Indeed, during the sectioning movement, the relative speed between the sharp edge of each blade 71 and the tubular body is nil.

Secondly, when the blades 71 move away from the valve rod 66, the trajectory followed by the sharp edge of each blade 71 is also done horizontally, but with a movement speed component against the bottom much greater than the movement speed of the tubular body with a great acceleration at the beginning of the movement, subsequently lessening quickly, thereby creating a propulsion of the “rolling” against the bottom and a fast and safe deposition, on the heads of the mandrel, owing to the accompanying of the blades 71.

This movement may be obtained using a connecting rod assembly placed appropriately and driven by an axis rotating continuously, for example, and by any other equivalent means.

Preferably, the blades 71 are open-worked toward the center of the sharp edge of the blade 71 with a half-moon shape with a size slightly larger than the diameter of the valve rod 66, such that when the blades 71 touch, an infinitely small play lies between the blades 71 and the valve rod 66. This cutting system thus guarantees the central hole in the “rolling”. It will be noted that the devices of the prior art have a high likelihood of closing the central hole, since when the blades come into contact with the tubular body, they crush the walls of the tubular body and bring them closer together, thus closing the central hole. Yet the central hole is essential to guarantee correct molding of a tube shoulder with an orifice having a skirt.

It will be noted that in this particular example embodiment, the cutting device 68 includes two blades 71 extending on either side of the valve rod 66; however, it is quite clear that the cutting device 68 may comprise more than two blades 71 without going beyond the scope of the invention.

Furthermore, it will be noted that the manufacturing device 4, the assembly device 5 and the flexible tube filling device 6 according to the invention, as previously described, may be implemented independently of one another, i.e., that each device may be used independently in any manufacturing and/or transformation installation for any components without going beyond the scope of the invention.

Lastly, it is clearly understood that the present invention is in no way limited to the embodiments described above, and that changes may be made thereto without going beyond the scope of the appended claims.

1. A device for manufacturing components from prefabricated tubular bodies, comprising:
means for supporting the components;
means for moving said components in line with a plurality of work stations; and
transport means along a main closed path for a plurality of satellite turrets rotatingly mounted on said transport means, said plurality of satellite turrets including means for holding a plurality of components, and each satellite turret of the plurality being rotated by a predetermined angle around a rotation axis when said satellite turret reaches at least one predetermined point of the main closed path.

2. The device according to claim 1, wherein the transport means comprise a main turret rotatingly mounted around a rotation axis.

3. The device according to claim 2, wherein the rotation axes of the satellite turrets extend parallel to the rotation axis of the main turret.

4. The device according to claim 1, wherein said satellite turrets are rotated in a direction opposite that of the main turret.

5. The device according to claim 1, wherein the predetermined angle of each of each satellite turret corresponds to a value of 360° divided by a number of means for holding said satellite turret or a multiple of the number of means for holding.

6. The device according to claim 5, wherein the rotation axis of each satellite turret is moved radially during at least part of its angular rotation around the rotation axis.

7. The device according to claim 6, further comprising radial movement means for moving the rotation axis of the satellite turret radially toward the rotation axis of the main turret during a first half of its angular rotation around the rotation axis, then radially toward its initial position during a second half of its angular rotation.

8. The device according to claim 7, wherein the device includes means for rotating each satellite turret.

9. The device according to claim 1, wherein the components comprise a plurality of prefabricated tubular bodies and the means for holding the plurality of components comprises a plurality of semi-cylindrical cavities, each cavity having an axis that extends parallel to the rotation axis of each satellite turret, over a circle coaxial to the rotation axis of each satellite turret, each cavity including suction means for keeping the prefabricated tubular bodies in place.

10. The device according to claim 9, further comprising a plurality of mandrels extending in line with the means for holding the plurality of components, the mandrels being able to move from a retracted position toward a treatment position in which each of the plurality of mandrels extends inside one of the plurality of prefabricated tubular bodies.

11. The device according to claim 10, further comprising means for actuating each of the plurality of mandrels from the retracted position toward the treatment position.

12. The device according to claim 11, wherein the means for actuating each of the plurality of mandrels comprises mechanical actuating means having a plurality of stationary mechanical cams extending around the main turret.

13. The device according to claim 1, wherein the satellite turrets are uniformly distributed around the rotation axis of the main turret.

14. The device according to claim 1, wherein the main turret is configured to rotate continuously.

15. The device according to claim 8, wherein said means for rotating each satellite turret are synchronized with the radial movement means of the rotation axis of each satellite turret so as to decrease a speed of a point of each satellite turret relative to the main turret.
